(19) United States
(12) Patent Application Publication
(10) Pub. No.: US 2007/0197260 A1
(43) Pub. Date: Aug. 23, 2007

(54) Interface for mobile devices and methods

(76) Inventors: Joshua Randall, Somerville, MA (US); Pascal Chesnais, Sudbury, MA (US); Eric Dufresne, Watertown, MA (US)

Correspondence Address: GAZDZINSKI & ASSOCIATES, 11440 WEST BERNARDO COURT, SUITE 375, SAN DIEGO, CA, 92127, US

(21) Appl. No.: 11/360,242

(22) Filed: Feb. 22, 2006

(51) Int. Cl. H04M 1/00; H04B 1/38

(52) U.S. Cl. 455/557; 455/556.1

(57) ABSTRACT

Apparatus and methods for providing a common interface for multiple applications and/or functions in a mobile communication device (MCD). In one exemplary embodiment, this common interface is provided by including one or more micro-servers within the MCD and capable of receiving and processing information from other functions, both internal and external to the mobile communication device. A micro-browser is also optionally resident on the MCD and in communication with the micro-server(s), the latter acting as an application server and as a proxy between the browser and external network agents such as web or carrier servers. The micro-server(s) can also act as a gateway to at least one asynchronous communication channel, and hence allows for more efficient browsing by the MCD.

### BACKGROUND OF THE INVENTION

1. Field of Invention

The present invention is related to the field of wireless communications. More particularly, the present invention is directed to apparatus and methods for providing a common interface for multiple applications and functions in a mobile communication or other such portable personal electronic device.

2. Description of Related Technology

Mobile devices such as cellular telephones, personal digital assistants (PDAs) and personal information managers (PIMs), hereinafter collectively known as mobile communication devices (MCDs) are well known. As the computing power of such mobile communication devices (MCD) has increased, their functionality, including number and diversity of user applications and functions, has also increased.

The increased functionality of such MCDs has allowed them to perform many of the functions traditionally associated with larger computers and PCs including Internet browsing, contact list management, e-mail, chat, games, video and audio functions (including MP3 storage and playback, and other such music-related functions), and system/network applications (e.g., local or personal network communication and management, such as via WiFi, Bluetooth or other comparable interfaces). For example, many mobile communication devices include a “micro” web browser for viewing web pages over the Internet. These micro web browsers provide many of the features of standard web browsers including rendering HTML pages and documents, displaying images, and receiving various types of input from the user.

WAP stacks and similar wireless protocol suites are also common in such mobile devices. As is well known, the Wireless application protocol (WAP) is an application environment and associated set of communication protocols for wireless devices that is designed to enable manufacturer- and technology-independent access to advanced telephony services as well as the Internet.

WAP is designed to be independent of the network, bearer, and terminal used. Mobile subscribers can access substantially the same information from a mobile device as they can from the desktop. The WAP specifications define a set of protocols in application, session, transaction, security, and transport layers. WAP also defines a wireless application environment (WAE) aimed at enabling the development of advanced services and applications including for example “micro-browsers”, scripting facilities, World Wide Web (WWW)-to-mobile-handset messaging, e-mail, and mobile-to-fax access. Based on-the Internet model, the mobile wireless device contains a micro-browser, while content and applications are hosted on Web servers.

WAP Applications are often written in wireless markup language (WML), which is a subset of extensible markup language (XML), and uses substantially the same model as the Internet. WAP utilizes Internet standards such as the user datagram protocol (UDP), and Internet protocol (IP). Many of the protocols are based on Internet standards such as hypertext transfer protocol (HTTP) and TLS, yet have been optimized for the unique constraints of the wireless environment (e.g., lower bandwidth, higher latency, and less connection stability/dropouts).

Internet standards such as hypertext markup language (HTML), HTTP, TLS and transmission control protocol (TCP) are generally less efficient over mobile networks, requiring larger amounts of data to be sent. Standard HTML content often cannot be effectively and completely displayed on the small-size screens of mobile devices.

Mobile protocols such as WAP utilize a substantially binary transmission for greater compression of data, and is optimized for long latency and low bandwidth. For example, the WAP HTTP interface serves to retrieve WAP content from the Internet that has been requested by the mobile device. WAP sessions are adapted to cope with intermittent coverage, and can operate over a wide variety of wireless transport mechanisms.

Client-Server Architectures

Client-server architectures are well known, and commonly employed in mobile communications device networks, such as in the aforementioned WAP mobile device architecture. There are many intrinsic benefits to such a client-server relationship, including for example allowing much of the functionality necessary to access a given service being distributed to mobile device users to a centralized location (server) so as to obviate placing these functions on the comparatively “thin” (i.e., less computationally and storage-capable) mobile devices. However, there are certain disabilities with a traditional client-server arrangement; i.e., where the server function is disposed entirely off-device. For example, under such architectures, a web browser on an MCD interfaces directly (or indirectly) with the remote server software process, and hence latencies can be introduced. The synchronous nature of certain types of connections must often be obeyed, and this leads to some degree of “bottlenecking” when attempting to access various different functions simultaneously.

Network proxies (e.g., intermediary or “stand-in” functions) are also well known in mobile device architectures such as e.g., WAP. The proxy can in certain circumstances act as somewhat of a “buffer” between the remote client process (e.g., micro-browser) and the distant server process, thereby improving overall function of the mobile communications link. However, such proxy devices are typically disposed on the network side of the client-network communications channel, thereby not addressing many issues created within the internal client software (and hardware) environments.

Based on the foregoing, an improved client-server architecture is needed wherein mobile devices can utilize and maintain the benefits of the traditional client-server relationship, yet which will also optimize the operation of the mobile device for operations such as, e.g., web browsing, data download, etc. Such improved apparatus and methods would ideally allow for an internal proxy or buffer within each MCD, thereby removing the aforementioned “bottlenecks” and hence improving the user browsing and network interface experience. This proxy would allow, inter alia, for asynchronous communications to occur between the MCD and one or more external devices (such as via alternate communications channels available to the MCD), as well as synchronous operations.

User Interface Limitations

One salient problem associated with existing mobile devices relates to how to allow a “commodity” web browser running on the mobile device to seamlessly access resources of: (i) the device, (ii) the carrier or service provider, and (iii) external networks or agents such as the Internet or a WAP gateway or proxy. Access to these various functions and services is typically split up among several user interface technologies. Often, the device operating system (O/S) provides a built-in user interface (UI) to access core functionality such as telephony features, “home screen,” and the menu system. On some devices, the O/S also provides one or more separate user interface libraries for native and/or third-party applications. For example, a mobile communication device may include a set of functions for configuring the device and, e.g., organizing contact lists or the like, setting system or network preferences, ring tone, wallpaper, volume, etc. Many of these functions typically include a separate interface (and the associated software to implement the interface). Other functions performed by mobile communication device applications include e-mail, chat and text messaging, audio, and video, each of which may also incorporate their own unique interface and application(s).

The browser embodies yet another user interface, used to access Internet web sites or other network locations. The result is that on many terminals, three or more user interface technologies are being used contemporaneously, and the end users are required to learn to use multiple paradigms for navigation, and to become accustomed to the different designs of each. This is particularly problematic when these interfaces are used infrequently, thereby causing the user to have to operate by trial-and error, access “help” functions, user's manuals, etc. in order to execute the desired functions associated with these interfaces.

Moreover, users who choose to upgrade to a new device often find completely different user interface technology because they have changed to a different device manufacturer. This problem often even extends to a different series device from the same manufacturer.

Additionally,.the use of multiple interfaces also increases the development complexity from a platform and software development perspective, as a new interface must be developed for each new function on the mobile communication device.

Using multiple GUI or other user interfaces to control the different applications and functions of a mobile communication device also increases the total program memory needed by that mobile communication device.

Although the idea of using a markup-language (ML) based browser as the primary user interface on a mobile device is relatively new, several mobile browser vendors are as of the date of this disclosure promoting their browser products as potential solutions to address the need for a unified “look and feel” within a mobile device (and across families of related devices). However, these proprietary solutions fail to completely address the underlying problem, in effect shifting the issue from the cognizance of the mobile device (e.g., smart-phone or PDA) manufacturers to the browser manufacturers. Thus far, solutions offered by browser manufacturers to enable access to device functionality have primarily involved extending the browser with additional APIs in order to make that browser more accessible to/by the various functions and applications on the device. Since each manufacturer has chosen to implement their own proprietary APIs, and since none of these APIs have been standardized, services written to one browser would almost certainly not interoperate with another. From the perspective of the end user (and the carrier/service provider), it would be highly beneficial to have a “universal” architecture wherein a given service or function could be authored once, used on many different devices, and accessed using many different browsers.

A variety of other approaches to implementing user and applications interfaces in mobile communication devices are present in the prior art. For example, U.S. Pat. No. 6,411,989 of Anupam, et al. issued on Jun. 25, 2002 entitled “Apparatus and method for sharing information in simultaneously viewed documents on a communication system” which discloses that computer users may utilize different web browsers to access a server system on the World Wide Web (WWW) to create or join a collaborative session. One or more controllers connect the users or collaborators in a session in the server system. This is realized by establishing a so-called “shared Web-top”, i.e., a work space, in which different in-document applications can be run and can be interactively, collaboratively shared by a plurality of users. Specifically, this is realized by employing a surrogate that includes a polling loop which periodically checks a shared document structure for changes in prescribed properties, and transmits the detected changes to surrogates of other users, i.e., at least one other collaborator, via a communication channel. To this end, a prospective user of the shared Web-top accesses a system, which transmits mobile code to the user's computer to create a surrogate thereon. The surrogates created for the users of the shared Web-top are connected by at least one controller in the system and individually serve as an interface between the controller and the respective browsers on the users computers. Through use of the polling loop in the surrogate, functionality is realized in which, as one user inputs data into a shared document, for example, into one or more forms in a document, the same data appears in the other user's browser, via the detected changes in prescribed properties of the one or more forms being transmitted over the communication channel to the users' computers and, therein, to their surrogates.

Another example of an interface for a mobile communication device is disclosed in U.S. Pat. No. 6,501,956 of Weeren, et al. issued on Dec. 31, 2002 entitled “Providing blended interface for wireless information services”, wherein a user interface between a wireless communication device and an information service provider is disclosed. The interface allows for a blended presentation of information and calling services for implementing an information service to a user of a wireless communication device. The user establishes an initial connection with a data network server to receive a particular service. The data network server sends a set of wireless protocol instructions to the user's mobile device. Based on these instructions, the mobile device will display information to the user which can be used to select a particular service. While preferably presenting a continuous display to the user, the wireless protocol instructions initiate a communication connection between the mobile device and a voice server with speech recognition capabilities. Depending on the service selected and identification of the user by whatever means, including call signals, the voice will run a particular voice application which interacts verbally with the user to perform the desired service allowing the user to control the service without the necessity of entering data or information using the keypad on the mobile device. As seen by the user, there is a continuous connection with the selected service from the initial receipt of the wireless protocol instructions to the final receipt of the requested information. Thus, the user is presented a blended data and voice interface for access to the information service.

U.S. Pat. No. 6,374,305 to Gupta, et al. issued Apr. 16, 2002 entitled “Web applications interface system in a mobile-based client-server system” discloses a mobile-based client-server system architecture that incorporates two specialized software layers—a specialized “proxy” layer that resides on a mobile client station, and a “web agent” layer that resides on a server. A conventional web browser application residing on a mobile client station is configured to point to the proxy layer, which captures HTTP information request messages that are transmitted to, and received from, the web browser. The HTTP request messages are packed by the proxy layer within a selected communication transmission format for upstream transmission over a communication network, such as a wireless network. At the server, the web agent layer recovers the original, (i.e., “raw”) HTTP request messages, which are then sent to an appropriate web server for further processing. Responsive HTTP messages transmitted from a respective web server are captured by the web agent layer, which packs the responsive messages within the selected communication transmission format for transmission to the client station. At the client station, the proxy layer recovers the raw HTTP response messages, which are then forwarded to the web browser for processing. The respective proxy and web agent layers preferably employ respective memory caches and have intelligent filtering capabilities, thereby reducing redundant or otherwise unwanted message transmission.

United States Patent Publication No. 20010054087 to Flom, et al. published Dec. 20, 2001 entitled “Portable internet services” discloses a content manufacturing and distribution system for manufacturing, distributing and caching content over wireless or wired Internet to portable devices. The system includes at least one portable device, the portable device capable of presenting users with portable device applications and content that are based on at least one of the user's community and personal preferences, the portable device including a cache for caching content packages on the portable device. A content manufacturing system processes information, data, and application objects from general external sources and community sources, and creates structured, searchable content packages relevant to at least one of a community, geography, and type of portable device. At least one internet server distributes the content packages over the wireless or wired Internet to portable devices based on at least one of community and user preferences. In response to a user submitting a request to the portable device application, the portable device cache is searched and used to fulfill the user request when relevant content packages are available in the portable device cache for fulfilling the request. User requests that require content not available in the portable device cache are routed to the at least one wired or wireless Internet server and content packages fulfilling the request are streamed down to the portable device, fulfilling the user request and updating the portable device cache so that subsequent user requests have access to the updated cache.

In light of the disabilities arising from the use of multiple interfaces in a mobile communication device, it would be highly beneficial to reduce the number of interfaces incorporated into a mobile communication device, while still supporting all the desired functionality including mobile device functions, data and messaging services, local network resources, carrier provided services such as mail, directories, etc., and traditional Internet web sites. Such interface would also be selectively controllable to some degree in terms of “look and feel” and other properties.

It would also be desirable to provide improved apparatus and methods wherein a service or function could be authored (developed) once, and used on many different devices and accessed using many different “commodity” browsers.

### SUMMARY OF THE INVENTION

The foregoing needs are satisfied by the present invention, which discloses methods and apparatus for providing a common interface for multiple applications in a mobile communication device.

In a first aspect of the invention, a mobile communications device with “micro-server” architecture is disclosed. In one embodiment, the mobile communication device has at least one wireless interface, and further comprises: a display unit configured to display information for a user; an input unit configured to receive input from the user; a microprocessor for executing software comprised of a plurality of modules; a memory unit in data communication with the microprocessor, the memory unit being capable of storing the software, wherein the software modules are adapted to perform one or more functions of the mobile communication device, the modules comprising at least: an application module; a server module configured to generate first data in response to information provided by the application module; and a browser module for displaying via the display unit the first data, and second data received from an external server.

In a second embodiment, the mobile communications device, comprises: a processor; a storage device in data communication with the processor; a wireless interface; and a web server process running on the processor, the web server process also acting as an application server, the server process being adapted to dynamically generate data upon request from one or more entities associated with the mobile communications device. In one variant, the web server process further functions as a gateway to at least one asynchronous communication channel. In another variant, the web server process further functions as a proxy between a browser and a network entity.

In a third embodiment, the mobile communications device comprises: a processor; a storage device in data communication with the processor; a wireless interface; and a server process running on the processor, the server process acting as an application server, the server process being capable of dynamically adding at least one new interfaces to a device functions using an “always-on” configuration capable of receiving updates to services on the mobile device substantially automatically.

In a fourth embodiment, the mobile device comprises: a microprocessor; a storage device in data communication with the microprocessor; a wireless interface configured to receive first information from a network server; a display unit for displaying information to a user; a configuration application running on the processor and adapted to configure at least one aspect of the mobile communication device, the configuration application providing configuration information using at least an application programming interface (API); a micro-server for generating second information in response to the information from the configuration application; and a micro-browser configured to display the first information and the second information on the display unit. In one variant, the first and second information comprise data rendered in a hypertext transport protocol (HTTP) format.

In a second aspect of the invention, a method of operating a mobile communication device is disclosed. In one embodiment, the mobile device comprises a display, browser and server, and the method comprises: controlling the display using at least the browser; providing a first set of data to the browser using the sever; and providing a second set of data to the browser from an external server in data communication with the mobile communication device. In one variant, the mobile communications device further comprises a mail application and a data store, and the method further comprises: requesting access to the mail application using at least a request from the browser; forwarding the request to the mail application using the server; generating a document using information stored in the date store, at least portions of the document being viewable using the browser; transmitting the document to the browser using the server; and displaying the at least portions of the document using the browser.

In a third aspect of the invention, a software architecture for use in a mobile communications device operated within a mobile communications network is disclosed. In one embodiment, the architecture comprises: at least one first function operative to run on the device; at least one second function external to the mobile communications device; at least one common interface for the plurality of functions, the at least one common interface comprising a server process adapted to at least receive and process information from both the at least first and second functions. The architecture further comprises a browser process in data communication with the server process, and the processing comprises at least one of: (i) formatting the information and delivering information to the browser process; and (ii) receiving input from the browser process generated in response to user input thereto; and forwarding at least a portion of the input to the at least one first application.

### BRIEF DESCRIPTION OF THE DRAWINGS

FIG. 1 is an elevational view of a mobile communication device configured in accordance with one embodiment of the invention.

FIG. 2 is a simplified block diagram of the exemplary mobile communications device of FIG. 1.

FIG. 3 is a block diagram of a wireless network (including mobile communications device(s) of FIGS. 1 and 2) configured in accordance with one embodiment of the invention.

FIG. 4 is a block diagram illustrating the configuration and operation of a mobile communication architecture according to a first exemplary embodiment of the invention.

FIG. 4a is a block diagram further illustrating the configuration and operation of a mobile communication architecture according to a second exemplary embodiment of the invention.

FIG. 4b is a block diagram further illustrating the configuration and operation of a mobile communication architecture according to a third exemplary embodiment of the invention.

FIG. 4c is a block diagram further illustrating the configuration and operation of a mobile communication architecture according to a fourth exemplary embodiment of the invention.

FIG. 5 is a flow chart illustrating the steps performed when interfacing with an electronic mail (e-mail) application in accordance with one embodiment of the invention.

FIGS. 6a and 6b are flow charts illustrating the operation of a mobile communication device in accordance with one embodiment of the invention.

FIG. 7 is a flow chart illustrating the operation of a mobile communication device in accordance with another embodiment of the invention, wherein the micro-server of the mobile device acts as a proxy.

FIG. 8 is a block diagram of one exemplary implementation of the mobile device according to one embodiment of the invention, including micro-server and micro-browser capability.

### DETAILED DESCRIPTION OF THE INVENTION

Reference is now made to the drawings wherein like numerals refer to like parts throughout.

As used herein, the terms “network” and “bearer network” refer generally to any type of telecommunications or data network including, without limitation, wireless and Radio Area (RAN) networks, hybrid fiber coax (HFC) networks, satellite networks, telco networks, and data networks (including MANs, WANs, LANs, WLANs, PANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the terms “radio area network” or “RAN” refer generally to any wireless network including, without limitation, those complying with the 3GPP, 3GPP2, GSM, IS-95, IS-54/136, IEEE Std. 802.11, Bluetooth, WiMAX, IrdA, or PAN (e.g., IEEE Std. 802.15) standards. Such radio networks may utilize literally any air interface, including without limitation DSSS/CDMA, TDMA, FHSS, OFDM, FDMA, or any combinations or variations thereof including any linear or non-linear transform of RF signals using data to be transmitted.

As used herein, the terms “Internet” and “internet” are used interchangeably to refer to inter-networks or internetworking functions including, without limitation, the Internet.

As used herein, the terms “client device” and “end user device” include, but are not limited to, personal computers (PCs) and minicomputers, whether desktop, laptop, or otherwise, and mobile devices such as handheld computers, PDAs, and smartphones or joint or multi-function devices (such as the Motorola ROKR music and telephony device).

As used herein, the terms “mobile client device” and “MCD” include, but are not limited to, personal digital assistants (PDAs) such as the “Palm®” or RIM “Blackberry” families of devices handheld computers, personal communicators such as the Motorola Accompli or MPx 220 devices, J2ME equipped devices, cellular telephones or “Smartphones” such as the Motorola A845, “SIP” phones such as the Motorola Ojo, personal computers (PCs) and minicomputers, whether desktop, laptop, or otherwise, or literally any other device capable of receiving video, audio or data over a network.

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a client device or other device.

As used herein, the term “application” refers generally to a unit of executable software that implements a certain functionality or theme. The themes of applications vary broadly across any number of disciplines and functions (such as communications, instant messaging, content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the Java™ environment.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ (including J2ME, Java Beans, etc.) and the like.

As used herein, the term “server” refers to any computerized component, system or entity regardless of form which is adapted to provide data, files, applications, content, or other services to one or more other devices or entities on a computer network. For example, a server may comprise a computerized device having a software process running thereon. A server may also comprise a software process, function or entity itself.

Additionally, the terms “selection” and “input” typically refer without limitation to user input using a keypad or other input device or function (such as a speech recognition algorithm), as is well known in the art. Input or selection also may refer, for example, to information received in electronic form from another entity or device.

As used herein, the term “speech recognition” refers to any methodology or technique by which human or other speech can be interpreted and converted to an electronic or data format or signals related thereto. It will be recognized that any number of different forms of spectral analysis such as, without limitation, MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “display” means any type of device adapted to display information, including without limitation CRTs, LCDs, TFTs, plasma displays, LEDs, incandescent and fluorescent devices. Display devices may also include less dynamic devices such as, for example, printers, e-ink devices, and the like.

As used herein, the term “database” refers generally to one or more tangible or virtual data storage locations, which may or may not be physically co-located with each other or other system components.

As used herein the term “browser” refers to any computer program, application or module which provides network access capability including, without limitation, Internet browsers adapted for accessing one or more websites or URLs over the Internet, as well as any “user agent” including those adapted for visual, aural, or tactile communications.

Overview

In one aspect, the present invention comprises apparatus and methods for providing a common interface for multiple applications and/or functions in a mobile communication device. In one exemplary embodiment, this common interface is provided by including a micro-server or other comparable software process within the mobile communication device and capable of inter alia, receiving and processing information from other functions, both internal and external to the mobile communication device. This processing includes, for example, formatting the information and delivering information over an HTTP or other link to a micro-browser that is also resident on the mobile communication device (or even an associated yet physically separate device). Processing by the micro-server also may include receiving input from the micro-browser generated in response to user input, and formatting and forwarding that information to the corresponding function or application. In one embodiment, the disclosed architecture includes a web server running on the mobile device, which also acts as an application server that dynamically generates data upon request.

In the exemplary configuration, the “micro-server” architecture is fully standards-based. Use of the micro-server also advantageously allows the client-server architecture inherent in networks such as the Internet to be preserved.

The micro-server can also be aware of other network technologies available to the device, and can make more efficient use of the network by acting as a gateway to alternate communications channels (e.g., asynchronous data channels), caching appropriate data locally, and receiving data asynchronously for later use. It can also act like a proxy between the browser (and other entities, such as WAP clients) and networks (including e.g., distant servers, WAP gateways or proxies, etc.), thereby making web browsing more efficient.

The micro-server approach described herein also provides a great deal of flexibility in terms of adding new interfaces to device functions; in one embodiment, this is accomplished via an “always-on” configuration which can receive updates to services on the mobile device automatically. Furthermore, extended functionality from the browser can in many cases be provided simply by extending the micro-server with additional functionality, while keeping the same “commodity” browser and avoiding customized implementations thereof on each different mobile device.

Additionally, the micro-server of the present invention can add value to the browser interface by enabling connection cost and billing information to be presented and managed from the browser itself, thereby making the mobile device more user-friendly from, inter alia, a cost efficiency standpoint. It also optimizes the network usage for the service provider or carrier.

The disclosed micro-server architecture is also advantageously scalable based on, e.g., the mobile device capabilities. The micro-server(s) can range from a simple server function (e.g., HTTP server) on one device, to a full application server or similar server on another device. These functions can also be combined across-two or more such micro-servers on the same device.

### Detail Description of Exemplary Embodiments

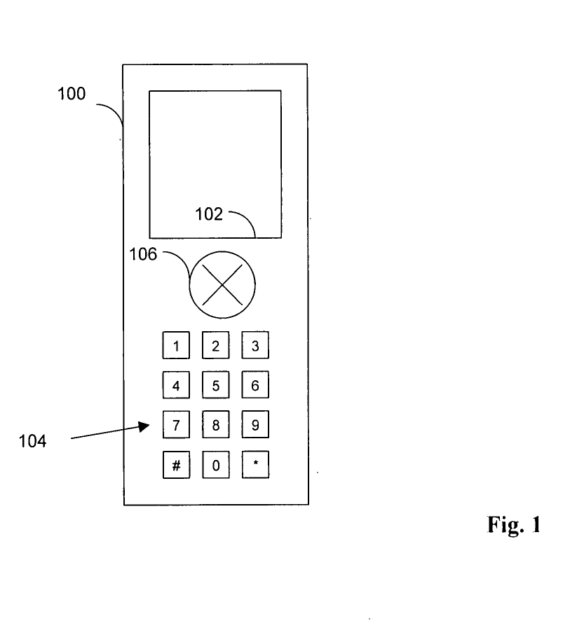

Referring now to FIGS. 1-8, exemplary embodiments of the apparatus and methods of the present invention are described in detail. While these exemplary embodiments are described in the context of a mobile communications system architecture connected through an IP Gateway to a Cellular Service Provider (CSP) having digital networking capability and a plurality of mobile communication devices (MCDs), the general principles and advantages of the invention may be extended to other types of networks and architectures, whether wired or wireless, broadband, narrowband, or otherwise, the following descriptions therefore being merely exemplary in nature. For example, these techniques could conceivably be employed in the context of a public switched telephone network (PSTN), WiMAX network, or personal area network (PAN).

Additionally, while described primarily in the context of the well-known Transport Control Protocol (TCP) and Internet Protocol described in, inter alia, RFC 791 and 2460, it will be appreciated that the present invention may utilize other types of protocols (and in fact bearer networks to include other internets and intranets) to implement the described functionality.

It will also be recognized that while described generally in the context of a network providing service to a customer (i.e., cellular telephone user) end user domain, the present invention may be readily adapted to other types of environments including, e.g., commercial/enterprise, and government/military applications. For example, the network might comprise an enterprise intranet communicating between various corporate campuses.

Throughout the application various functions are ascribed to various systems connected in various configurations. It should be understood that the configurations shown are only exemplary embodiments of the invention, and performing the same or similar functions in other configurations or using other methods is consistent with other embodiments of the invention.

Also, it will be recognized that the various systems than make up the invention are typically implemented using software running on semiconductor-based microprocessors or other computer hardware systems, the construction and operation of which is well known in the art. Similarly, the various logical processes and algorithms described here are also typically performed by software running on a microprocessor, although other implementations, including firmware, hardware, and even human performed steps are consistent with the invention.

FIG. 1 is a simplified block diagram of a mobile communication device configured in accordance with one embodiment of the invention. The mobile communication device (MCD) 100 includes keypad 104 used for the input of information including for example telephone numbers and contact names, and a display 102 for viewing information. Additionally, the mobile communication device 100 may include a scroll wheel 106 of the type pervasive in the art for moving through menus and other input and selection activities. Other input devices well known in the art including, e.g., a full keyboard or a mouse replacement such as jog wheels and touch screen, and/or non-tactile inputs such as speech recognition (e.g., CELP-based voice compression), are consistent with the use of embodiments of the invention as well.

During typical operation, a user of the MCD may input numbers, names and other contact or directory information into the MCD 100 via keypad 104. Such contact information may also be downloaded via other connections to MCD 100 (not shown) including wire line and wireless connections (e.g., a Bluetooth/SyncML interface and protocol), or the contact information may be collected as calls are made and received, such as by an indigenous software application adapted for such functionality.

Additionally, a user may interact with other applications such as web browsers, chat applications, e-mail and configuration functions for configuring the mobile communication device, using the keypad 104 and/or the scroll wheel 106. Information resulting from this input is also optionally displayed on the MCD display 102.

The MCD 100 is in one embodiment a cellular telephone or “smart-phone” having at least one wireless air interface or radio area network (RAN) associated therewith, but any other type of mobile or nomadic communication device may be employed in certain embodiments of the invention. For example, a laptop computer with a wireless interface connection such as a Wi-Fi or 3G card could be used as an MCD 100.

The MCD 100 preferably interfaces with a base station or other access point via modulated radio frequency electromagnetic signals (RF signals) that are modulated in accordance with one or more communications standards. Examples of useful standards include, inter alia, GSM, CDMA-2000, W-CDMA, EDGE, IEEE 802.16, 802.15 or 802.11. The use of other standard or non-standard/proprietary wireless interfaces is also consistent with the invention. Multiple such interfaces may also be used, such as where the MCD has a primary (cellular) air interface, as well as a WiFi and/or Bluetooth interface.

Typically, the MCD 100 will include one or more microprocessors, and memory for storing programs that are executed by the microprocessor(s). Other signal processing capability may be used, such as where a DSP is used for processing of visual, audio, or other data, in conjunction with a “host” or other processor such as the well known ARM7 family of RISC devices. Software of the type well known in the art controls the operation of the MCD including processing input, generating display data and menu structures, and generating messages to be transmitted via the wireless link.

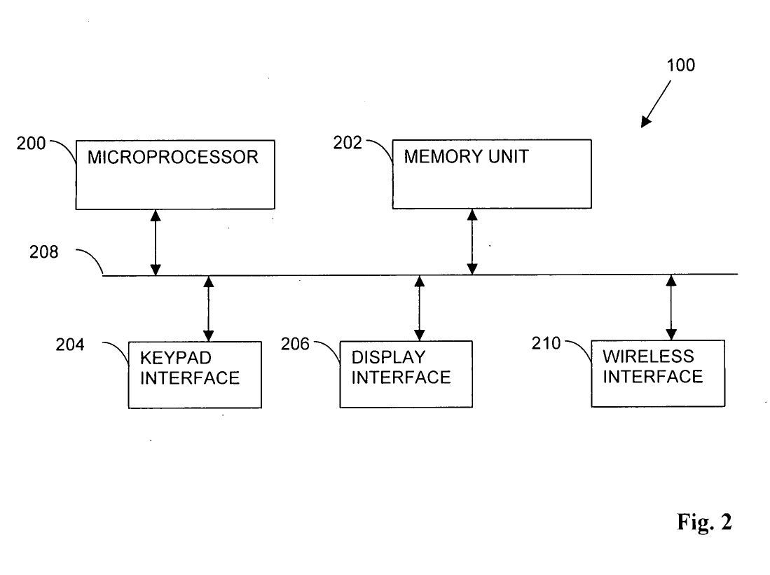

FIG. 2 is a simplified block diagram of mobile communications unit configured in accordance with one embodiment of the invention. The microprocessor 200 and memory unit 202 are coupled to a data bus 208. The memory unit 202 can include RAM, ROM and any other data storage device included in the mobile communications unit, although these storage functions may also be distributed across various components (such as where a microprocessor or DSP has on-chip SRAM, in addiction to discrete DRAM, or on-board cache memory within the microprocessor 200). The memory unit(s) 202 stores, inter alia, the software instructions that control the operation of the mobile communication device.

Other functional units are also coupled to the data bus 208 including, e.g., a keypad interface, display interface, and wireless interface 210. These interfaces provide input-output functions to their respective systems within the mobile communications unit. For example, data is transmitted to and received from external entities via the wireless interface 210. Input is received from keypad interface 204, and the information to display is transmitted through display interface 206.

It will be understood that other configurations of the MCD 100 are consistent with various other embodiments of the invention, including for the use of multiple data buses and direct connections (e.g., DMA or the like) between various elements of the mobile communication device, including the microprocessor. The device architecture may also be optimized for certain functions, such as power conservation, gaming/video applications, etc. For example, various of the functions described herein may also be configured with “sleep modes” of the type well known in the art in order to conserve precious mobile device power when such functions are not in use.

Additionally, the various elements of FIG. I may be combined into single functional units or chip-level aggregations (e.g., SoC devices), or separated into multiple functional units which together provide the same or similar functionality. Multiple entities providing similar functionality may also be used including, e.g., two microprocessors that are focused on performing different tasks, such as one microprocessor for controlling the wireless interface, and another microprocessor for controlling the application functions.

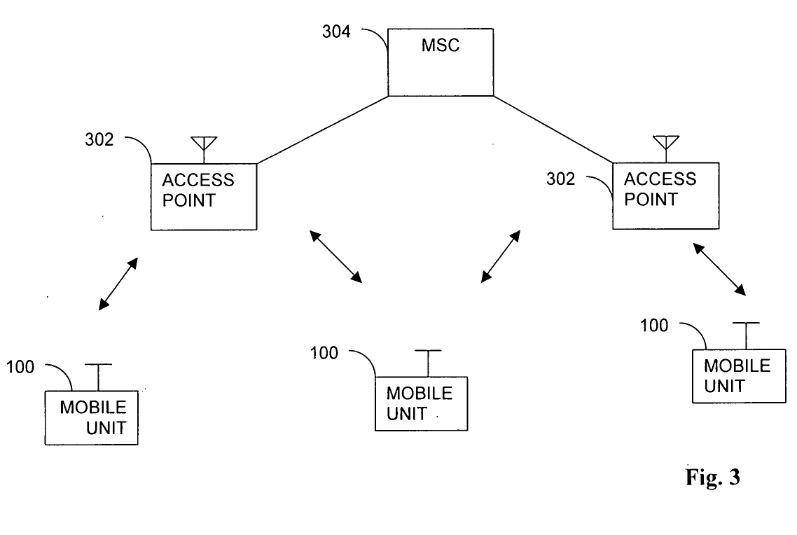

FIG. 3 is a functional block diagram of a wireless network configured in accordance with one embodiment of the invention. The mobile communication devices (labeled as mobile units in the Figure) 100 interface with one or more access points 302 via wireless RF signals. The access points 302 are then connected to a mobile switching center (MSC) 304. The MSC 304 is typically co-located with other equipment such as base station controllers (BSCs) and transcoding frames (TCFs), or the base station controllers, etc. may be located elsewhere in the system.

The access points 302 of FIG. 3 may comprise, for example, cellular base stations or wireless access nodes (e.g., WiFi access points (APs)) connected directly to networks such as LANs, WANs, or the Internet, or even other MCDs. In some embodiments, the MCDs 100 may communicate with one or more access points 302 depending on the location and status of the MCD 100. For example, in a handoff situation, a mobile unit 100 may be in communication with multiple access points 302 simultaneously. Alternatively, the “base station” 302 may comprise a Bluetooth “master” which can accommodate up to seven “slave” devices in a typical Bluetooth implementation.

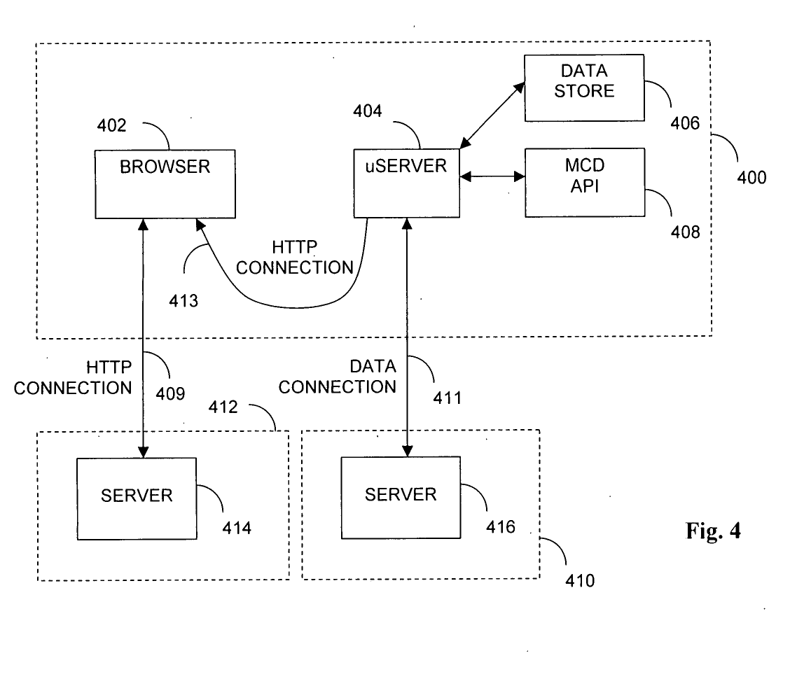

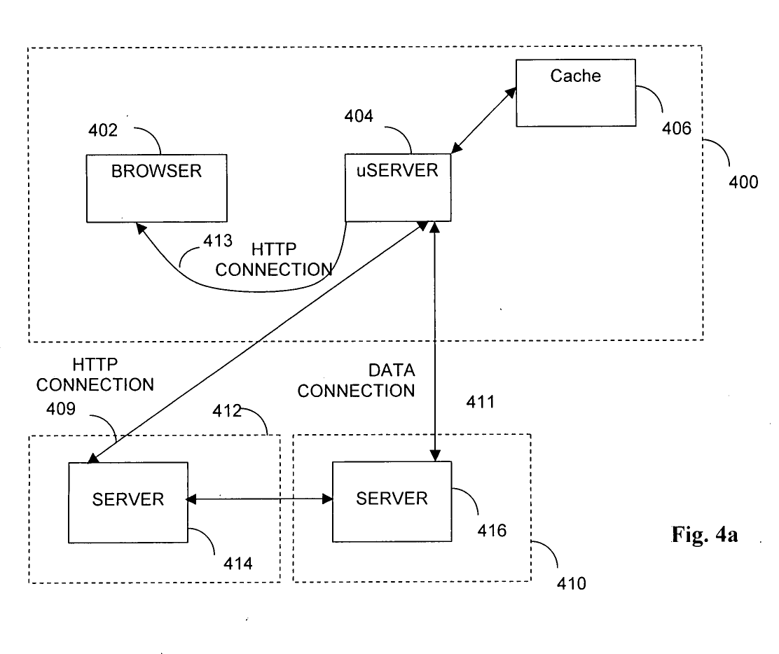

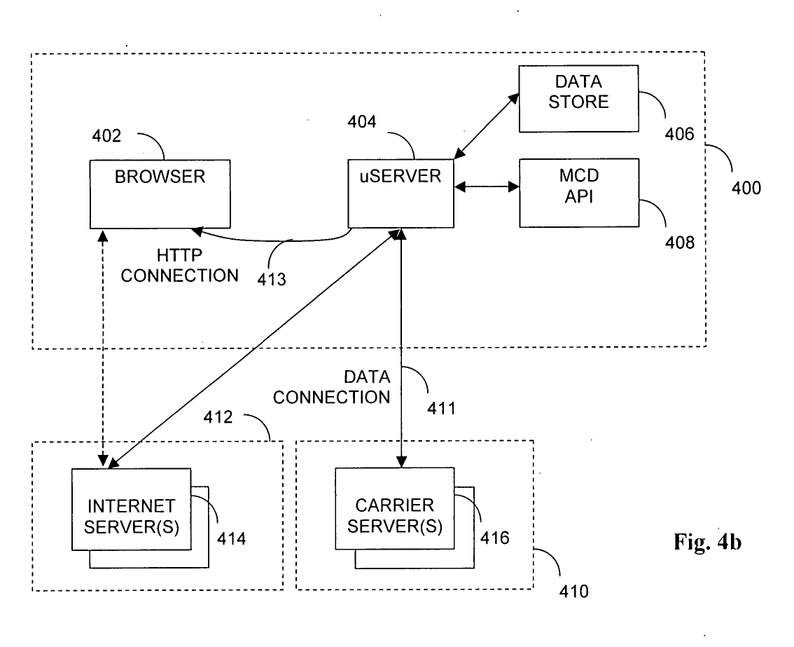

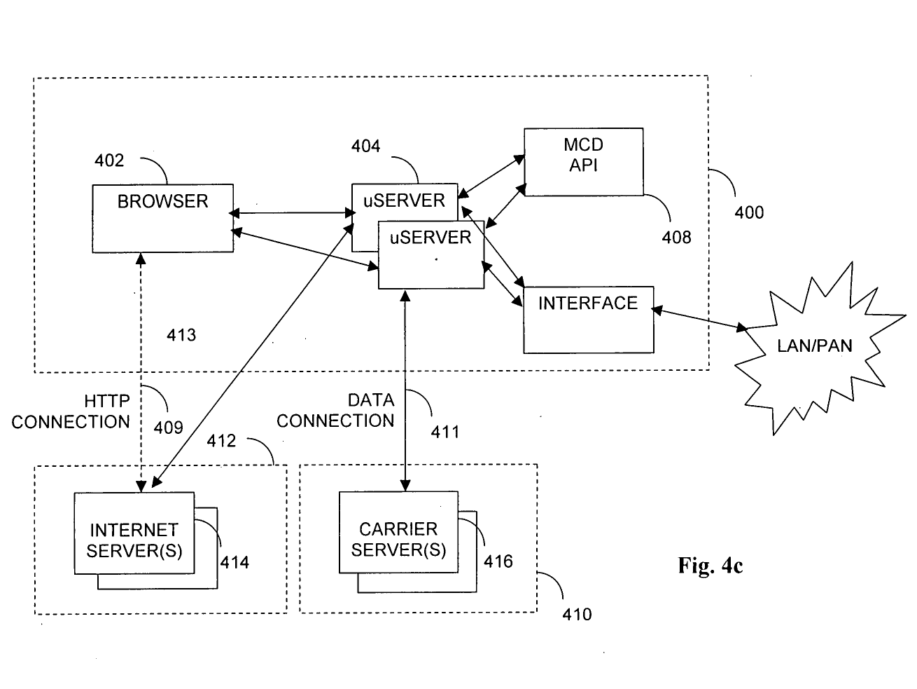

FIG. 4 is a block diagram illustrating the configuration and operation of a mobile communications architecture with micro-server in accordance with one embodiment of the invention. As will be described subsequently herein, the micro-server architecture provides many capabilities and benefits, including: (i) providing access to device functionality, (ii) caching network data for efficiency, (iii) proxy requests to other networks, (iv) receiving data over asynchronous channels, (v) extending the capabilities of the browser to handle new protocols, (vi) transcoding one protocol to another, (vii) dynamically tailoring contents to a particular device, (viii) managing resource/cost data, (ix) enabling billing interfaces to be presented along with browsing sessions, (x) allowing carriers greater control over the browsing experience on terminals, (xi) acting as a carrier point-of-presence on a mobile device, (xii) updating capabilities of a device over-the-air, and (xiii) enabling the use of commodity browsers as a general-purpose interface for a mobile device.

The illustrated mobile communication device 100 includes a browser 402 (e.g., one adapted for thin mobile client devices, such as a “micro-browser”), and a “micro” HTTP or similar server 404 (micro-server). The browser 402 and server 404 are typically software running on a microprocessor similar to that shown in FIG. 2, although other implementations are feasible.

As used herein, the term “micro” is purely a relative term that connotes that fact that the exemplary micro-server is adapted to run on a thinner or less capable device (as compared to a PC, BSC, or fixed server blade), and hence requires less processing and storage capability within the MCD. It will therefore be appreciated that the size, capabilities, and form of the server 404 and browser 402 may take on literally any configuration, dependent primarily on the platform on which these processes are used, and their desired levels of functionality.

The micro-server 404 also receives input data via one or more MCD application programming interfaces (APIs) 408, from data stored in a storage device 406 or other repository, and via a data connection 411. The browser 402 exchanges information with other modules via HTTP or other connections 411 and 413. This information is displayed on, for example, display 102 of FIG. 1. Information is also received via the various input devices of the MCD 400 including, for example, a keypad and scroll wheel as described above.

It will be recognized that while shown as part of the MCD 100 of FIG. 4, the aforementioned browser 402, server 404, and/or storage device 406 may also be located on another platform, and merely maintained in logical communication with the relevant entities within the architecture. For example, the data storage device 406 could comprise a database which is disposed on a different platform (e.g., local base station associated with a wireless handset). Similarly, the browser and server processes may be disposed on different physical platforms, yet maintained in data and logical communication with one another. The micro-server 404 can also be made part or integrated with another client application or process, such as where the micro-server comprises a module within an application (or the O/S) of the MCD 100.

A first server 414 may be any HTTP or similar server (including, without limitation, HTTP 1.0, HTTP 1.1, HTTP over SSL, HTTP over TLS, or WAP servers) located on the Internet 412 or other network, and in communication with the micro-server 404 running on the mobile communication device 100 via a circuit- or packet-switched data connection 409 (e.g., modem, packet gateway, etc.). A second server 416 runs within an operator's network 410 that is accessed via a second data connection 411. It will be appreciated that while HTTP-over TCP/IP protocol based connections 409, 411 are illustrated, other protocols may be used, as well as other transport modalities. These data connections can also be heterogeneous in nature, such as where an HTTP-over TCP/IP based approach is used for the first connection 409, and a non-TCP/IP approach (e.g., SMS or the like) is used for the second connection 411.

Furthermore, the system may comprise any combination of servers, including the case where only one of type of the first or second servers 414, 416 is used, as well as multiple first servers 414 and no second servers 416 (and vice-versa) or multiple servers of each type. Additionally, as described in greater detail subsequently herein, the second server 416 can be operated or managed by the network operator, or by a third party, and may be in data communication over any network, not just the operator's private network. The second data connection 411 could also comprise a more generic data source. Myriad other combinations and permutations will be recognized by those of ordinary skill provided the present disclosure.

During operation of the MCD 100, the browser 402 receives data to process/display from one or more of the HTTP connections 413, 409. The HTTP data from the HTTP connection 409 to the server 414 will typically be obtained from a web site or other URL being viewed by the MCD user, and may comprise either static data or dynamically generated data (e.g., that based on some input data or string, such as a query for a search engine). The HTTP data from the micro-server 404 may be from applications running on the MCD 100, and configured in compliance with an MCD API 408. Such applications can include, e.g., configuration functions, e-mail applications, and music or video related applications. It will also be noted that the methods and apparatus set forth in co-owned and co-pending U.S. patent application Ser. No. 11/317,473 filed Dec. 22, 2005 and entitled “METHODS AND APPARATUS FOR ORGANIZING AND PRESENTING CONTACT INFORMATION IN A MOBILE COMMUNICATION SYSTEM” and incorporated herein by reference in its entirety, may be used in conjunction with the present invention. Specifically, the enhanced “contact” management functions described therein can be used as the basis of an application or service running on the MCD and accessible by the micro-server 404. Data associated with this functionality can also be resident within the data store 406 of the MCD, and hence accessible via the micro-server 404, or as “static” information.

The micro-server 404 may also receive information from other servers such as the operator network server 416, which provides data by way of associated data connection 409. Additionally, the micro-server 404 may retrieve data from (or write to) data storage 406.

The micro-server 404 receives this information from the various sources, and places it in XML, HTML, SGML, or another suitable format or protocol as required before delivering it to the browser 402 for viewing. Similarly, micro-server 404 may receive data from the browser 402 that is then processed and forwarded to the appropriate system using, e.g., the API to indigenous applications on the MCD, and/or the data connection 411. In this fashion, the micro-server acts as a proxy for the browser, resident MCD applications, and the second server 416.

By providing a micro-server architecture that includes an API interface within the mobile communication device itself, the illustrated embodiment of the invention further allows for a more uniform interface to be provided to the user. In particular, the micro-server 404 allows the other applications on the MCD to transmit data to the user via the micro-browser 402 also included in the mobile communication device. Thus, other applications on the mobile communication device only have to provide the micro-server with the information that must be displayed, and the formatting, display and input reception functions may be handled by the micro-server and the micro-browser. Page: 23 This could be accomplished using any of a variety of means commonly employed by “application servers” such as the use of templates, server-side inclusions, style sheets, PHP, JSP, AJAX, or other such mechanisms well known to those of ordinary skill. More generally, the foregoing may be accomplished by any means of abstracting presentation/display from content. In certain embodiments, the applications may need to be configured to interact with the micro-server 404 before they can be used in this manner. However, regardless of the approach used, it will be appreciated that a salient benefit provided by the approach of the present invention is that the micro-server/micro-browser combination effectively handles the actual display, formatting, and user interface functions, such that the application itself does not need to provide any UI “code” of its own (rather, only an API to exchange content data with the micro-server).

Additionally, by viewing information received from external servers as well as the internal micro-server 404 using a single micro-browser interface, the user is provided more uniform experience when using the MCD. This approach advantageously reduces number of interfaces, menu structures, etc. that a user must learn and remember, and greatly simplifies the use of the mobile communication device, especially when the various functions are not frequently used. As is well known, the human memory fades significantly with time, and hence complicated access via multiple different interfaces can be easily forgotten if not frequently used. This leads to significant user frustration and dissatisfaction with the MCD and even the carrier's mobile service plan (i.e., by sponsoring or delivering subscriber devices that are unwieldy to operate).

Also, the micro-browser 402 of the illustrated embodiment is reused for multiple functions, which reduces the number of programs that must be incorporated into the mobile communication device, as well as reducing the size and complexity of each of the programs by eliminating the need for many different sets of UI code. While somewhat intangible and hard to predict, it is a well-identified phenomenon in computer systems that increasing numbers of applications and other programs running on a given system will tend to generate an increasing number of incompatibilities, often leading to the device “crashing”, locking up, or other types of undesirable behavior. This phenomenon stems largely from the fact that even when standardization is employed, different software vendors cannot test their applications against the plethora or other applications or programs that might be running on the same platform. Some applications simply do not operate well with other applications on the same platform. Hence, the present invention advantageously obviates the need for many of these other applications, thereby reducing system complexity (from a software perspective) and increasing robustness and reliability.

Furthermore, a use of a common interface as in the illustrated embodiment will reduce the programming necessary to create new applications for the mobile communication device 100. In particular, the programmer will not have to develop a complicated interface for the application before it can be added to the mobile communication device. The programmer only has to provide “hooks” in the program such that it operates with the mobile communication device application programming interface (API), the micro-server 404 and micro-browser 402, which handle the “standardized” interface function automatically. This saves development resources, as well as ostensibly saving the number of instructions that must be performed, thereby contributing to operational efficiency and potentially even reduced power consumption, a significant issue for mobile devices due to their finite battery power supply.

Like most HTTP or other such servers, the exemplary micro-server 404 may provide either static or dynamically generated data in response to a request by the user. In one embodiment, the user interacts directly with the browser 402 using the MCD 400 user interface (U/I). The browser 402 in turn exchanges data over the HTTP connection 409 with a server 414 on the Internet 412 or other external network, modifying the MCD display accordingly. The server 414 may provide static data in response to requests from the browser, or alternatively may dynamically generate data in response to each request from the browser by processing input data and possibly querying databases or otherwise gathering data. For example, a user may request a URL which requires only the return of static data from the server 414. Or, the user may enter a search string or other input data into the browser, at which point this information is forwarded to the server to initiate a database query (e.g., “Google” search or the like).

In the micro-server configuration, the same browser 402 is also used to exchange data using the HTTP connection 413 with the micro-server 404, as shown in FIG. 4. Much like the Internet server 414, the micro-server 404 provides either static or dynamically generated data in response to a request issued by the user/browser Static data may come directly from the data store 406 on the device (e.g., cached data which is commonly used by the MCD), while dynamically generated data can use the data connection 409 access other servers 416 on the network, access device functionality via the terminal API 408, and also access the data store 406 to store or retrieve data.

As will be appreciated, the caching of commonly used data in the data store 406 allows for an improved browsing experience for the MCD user, since the data can be rapidly accessed and transmitted to the browser 402 via the server 404.

Data can also be received by the micro-server 404 over the data connection 409 asynchronously, stored in the data store 406, and later transmitted to the browser over HTTP connection 413. In this manner, the micro-server 404 can act as a caching gateway between the browser and data accessed via other protocols. This is useful in a variety of situations, such as when the browser is otherwise occupied with other tasks, or protocol translation between two environments (e.g., the distant server and the browser) is required. The micro-server 404 can also act as a proxy server, fetching documents either from a cache in the data store 406 or receiving them via the data connection 409 and optionally adding them to the cache in the data store 406.

Various embodiments of the invention implement the micro-server 404 in different forms, ranging from e.g., a very simple (HTTP) server process, to a full-fledged application server (e.g. web application server). Exemplary commercial examples of web application servers include IBM WebSphere, BEA WebLogic, ATG Dynamo Application Server, and Jboss, although it will be recognized that other types and configurations or servers may be used with equal success.

One embodiment of the system includes a micro-server having both an HTTP server and a basic application server, including loadable plug-in modules and a templating system, although it will be appreciated that other functionality may be included in addition to or in substitution of the foregoing. In this regard, the present invention contemplates that the micro-server architecture is substantially modular as well, so that custom configuration (such as by MCD manufacturers or the user themselves) can readily be performed without significant software or hardware modifications.

In addition to basic XHTML documents, the micro-server 404 can preferably return any media type supported by HTTP or other such protocol used as the basis for the system, including but not limited to audio and video streams (e.g., MPEG-2, H.264, AVC, Real Networks or other encodings), CSS style sheets, ECMAScript programs, and raw XML data. Advanced client-server web technologies such as remote eventing and DOM load and save can be utilized to enable more fluid and dynamic user interfaces within the browser, while still respecting the client-server abstraction layer. Advantageously, applications running inside the micro-server 404 environment have access to any functionality exposed by the terminal API, as well as to any resource on the network.

Furthermore, it will be recognized that since the illustrated embodiment of micro-server requires no user interface of its own, it can be written in a less platform-dependent manner than one having a built-in UI. However, the present invention also contemplates a user-interface enabled variant, which is substantially platform dependent. Hence, the architecture is flexible in that it can be configured to be completely platform agnostic, or alternatively have varying levels of platform dependence based on the needs of the designer and software developer.

The micro-server based architecture of the invention also allows for enhanced efficiency in terms of data caching. For example, if a user was accessing a mail account on the Internet using the browser 402, the browser itself (e.g., in a prior art configuration) would not necessarily know that it would be more efficient to cache the attachments locally on the MCD for later use. However, using the micro-server 404, management of the selective caching of attachments, etc. (such as for example pre-caching attachments as messages arrive) can be provided, thereby increasing efficiency and user experience. The micro-server of the exemplary embodiment is in a better position than the browser to perform these functions because of its access to extended context information, such as may be provided by its access to the device API or to network information from an operator data source.

Moreover, the micro-server architecture of the invention allows for extended functionality to be obtained from the browser 402. In many cases, this extended functionality can be provided simply by extending the micro-server 404 with additional functionality, while keeping the same “commodity” browser. An example of one such technology that could be upgraded in the micro-server 404 instead of the browser 402 is the Dynamic Properties Framework (DPF) work that is currently progressing in the W3C. Rather than waiting for all browsers to support this Framework, a carrier or service provider utilizing micro-servers 404 in their subscriber devices (e.g., MCDs) could upgrade the micro-server to support DPF (such as via downloads over the wireless network), and provide access to dynamically changing device properties to any of the existing commodity browsers (which may also differ from MCD to MCD).

The exemplary architecture of FIG. 4 also allows multiple micro-servers or comparable processes to be present on a single mobile device. For example, multiple servers (see, e.g., FIG. 4c discussed subsequently herein) can be utilized in order to divide extended phone, data or other functionality between different parties, such as service providers and device manufacturers. For example, a device manufacturer could install a micro-server 404 on a mobile device 100 to provide a browser-based telephone/VoIP service, mail service, address book service, phone settings service, etc. On the same device, a service provider could install a separate micro-server 404 to provide access to operator-supplied data services such as news, weather, or sports scores, which are delivered asynchronously to the micro-server by the service provider network. Given the platform independence of this architecture, these multiple servers can be largely generic and also can be installed ad hoc; e.g., the subscriber could download one or more of the micro-servers onto their device over a data network (e.g., from a web server) and install the server directly into the existing MCD software environment. Stated differently, the software environment of the MCD 100 advantageously does not have to be reconfigured to accept multiple server processes running in parallel and in communication with the same browser 402.

From a software perspective, the exemplary micro-server architecture of FIG. 4 also leverages the benefits of web standards, such as separation of design from contents, which can make authoring new interfaces much easier. Using web technologies (such as markup-based content authoring languages and style sheets for determining “look and feel”) allows the software author to create one markup model, and use style sheets to subsequently manage the look and feel.

The micro-server approach allows a standards-based browser to be used, without modification, to access phone or other such functionality on the device, and also to access data that arrives at the device asynchronously and over many different data protocols. The major benefit is that any standards-based browser can be used with the system without requiring special proprietary extensions being added to support access to the various functions of the host platform (e.g., MCD 100).

FIGS. 4a-4c illustrate various alternate embodiments of the architecture of the present invention.

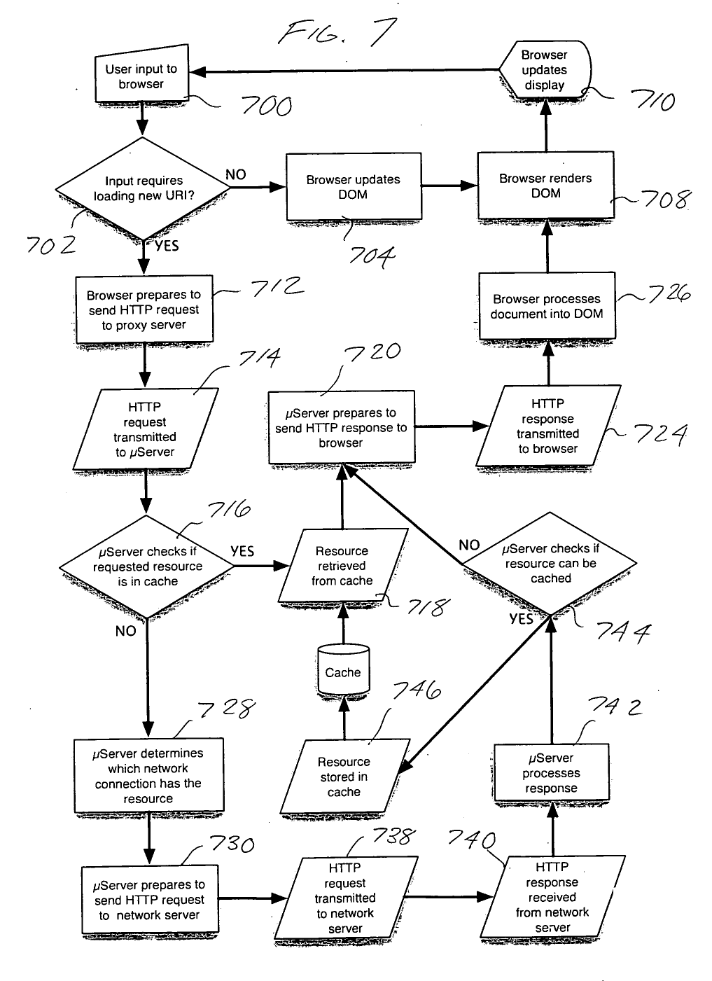

In FIG. 4a, a “proxy” configuration is illustrated, wherein the micro-server 404 acts as a proxy between the micro-browser 402 and external processes (such as the servers 414, 416). A detailed description of the operating principles of an exemplary proxy architecture such as that of FIG. 4a is described subsequently herein with respect to FIG. 7.

FIG. 4b is a hybridized architecture with both proxy and non-proxy (i.e., direct browser-to-web server) functionality.

FIG. 4c illustrates an architecture wherein the MCD 100 comprises two or more micro-servers, which also may act as proxies as in the embodiment FIG. 4a. A separate interface to a LAN or PAN is also in communication with the micro-server(s) 404.

It will be appreciated that the embodiments of FIGS. 4-4c are merely exemplary; features and attributes of each can be combined with others, or yet other configurations recognized by those of ordinary skill may be used with the architecture of the present invention.

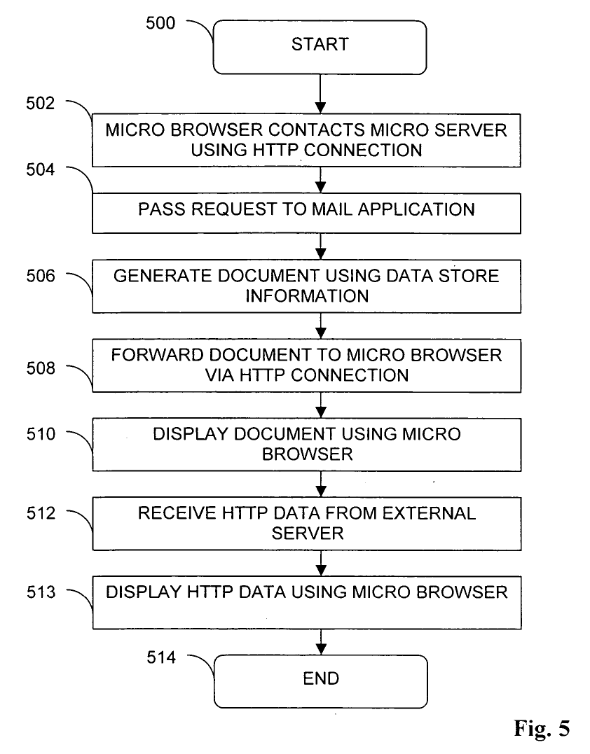

FIG. 5 is a flow chart illustrating the steps performed when checking e-mail in accordance with one exemplary embodiment of the MCD software environment of the invention. The process may be performed on systems such as those shown in FIGS. 2 and 4 herein, or on other configurations, the construction and use of which is well known in the art. The method 500 may also be adapted to other types of applications as well.

The process 500 begins at step 502, wherein the micro-browser 402 uses the HTTP connection 413 or other such interface to contact the micro-server 404 to request a mail application operation. The micro-server passes this request to the mail application at step 504, and at step 506, the mail application uses data from the data store (or data received through the MCD API) to generate a document or other data structure that in a format understood by the native browser.

At step 508, the micro-server 404 forwards the document/structure via the HTTP connection 413 to the micro-browser. The browser then processes and displays the document at step 510.

At step 512, the micro-browser receives HTTP data from an external server. At step 513, the HTTP information from the external server is displayed by the micro-browser. These steps or any portion thereof may be repeated as micro-browser retrieves additional resources from the micro-server or and external server or network agent as necessary.

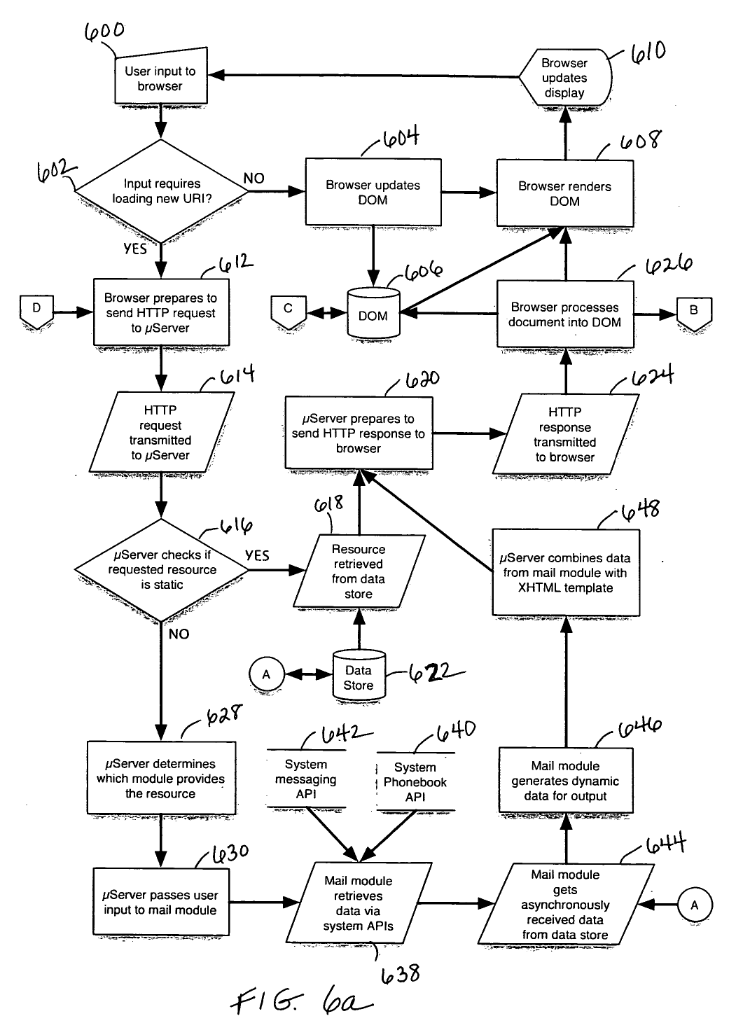

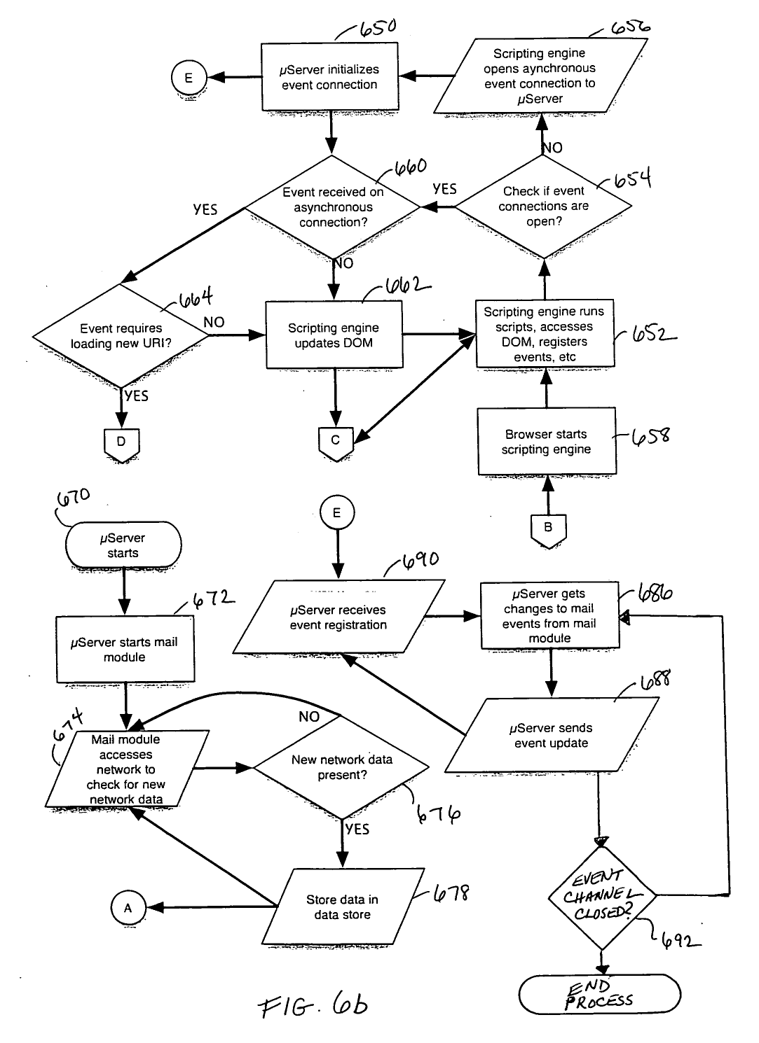

In one embodiment of the invention, scripting information (e.g., in the form of XML metadata, XHTML markup, ECMAScript, JavaScript scripting, or otherwise) contained in the document returned by the micro-server to the micro-browser may indicate that the micro-browser 402 of the MCD 100 should initiate a separate “event” connection to the micro-server 404 (see discussion of FIGS. 6a and 6b below). The micro-browser may then register to receive notification of updates to information contained within the micro-server. This notification can be event-driven (i.e., upon the occurrence of a given event), periodic, or otherwise. The micro-server is responsible for sending updates on this information to the browser over the eventing connection as they occur, although other schemes (such as a “pull” or request system wherein the micro-browser periodically request or polls the micro-server) may be utilized with equal success.

An example of data transferred according to the aforementioned event-based approach is a notification that new messages (which may be associated with a particular mail client or environment) have arrived for the user(s). This information is conveyed to the mail client application via the MCD API, which in turn processes and encodes the information in the form of an event, and transmits the information to the micro-browser over the previously established event connection. It will be appreciated that literally any level of information could be exchanged, from a very basic “notification” message (such as a single bit to indicate the presence of new data) to the complete set of content changes. The exemplary “remote event” framework described herein does not limit the data exchange to a particular type or format, but rather merely provides the means to open an event channel on which to exchange data asynchronously.

Other data links may also be formed by the mobile communications device 100. For example, the micro-server 404 may receive data over the data connection 411 from a server (e.g., web server) on the network. This data may be periodically requested by the micro-server, or may be transmitted asynchronously by the server or its proxy to the MCD 100, and may arrive at the micro-server 404 by other means, such as via the MCD API. The micro-browser/micro-server architecture of the illustrated embodiments may also be made compatible with other types of data links, including e.g., RAN or local wireless networks such as a WiFi LAN, Bluetooth PAN, or the like. These local wireless networks may be dynamically established and torn down (such as e.g., where Master/Slave relationships in a Bluetooth network are established, terminated, and then new relationships established, or STAs are added to an AP under a WiFi network).

FIGS. 6a and 6b are flow charts illustrating the operation of a mobile communication device in accordance with one exemplary embodiment of the invention. It will be appreciated that while described in the context of the exemplary architecture of FIG. 4, the methodology shown in FIGS. 6a and 6b (as well as FIG. 7 described below) are equally applicable to other types of architectures, and in fact other processes and logical flows can be used in place of those of FIGS. 6a-7. Herein lies a significant advantage of the invention; i.e. a substantial degree of agnosticism to the underlying network architecture.

At step 600 (FIG. 6a), the micro-browser receives user input of the type previously described. At step 602, it is determined whether the input requires loading of a new uniform resource locator (URL) and if not, the micro-browser updates the relevant data structure (e.g., document object model (DOM) 606) at step 604. At step 608, the micro-browser 402 next renders the DOM, and at step 610, the micro-browser updates the MCD display. The process then returns to step 600.

If at step 602 it is determined that the input requires loading a new URL, the browser 402 prepares to send an HTTP request to the micro-server 404 at step 612. This request is transmitted to the micro-server at step 614, and at step 616 the micro-server 404 determines if the requested resource is static. This is determined in the exemplary embodiment by the path to the resource (a commonly used means for web servers), although other approaches may be used with equal success. If so, the static resource is retrieved from the data store 622 at step 618. The micro-server 404 then prepares to send the HTTP response to the micro-browser at step 620. Then, at step 624 the HTTP response (including the requested static resource) is transmitted to the micro-browser. At step 626, the micro-browser processes the response document into a DOM. The micro-browser 402 then renders the DOM, and updates the MCD display.

If at step 616 it is determined that the requested resource is not static in nature, the micro-server 404 determines which module(s) within the MCD environment are needed to provide the requested resource (step 628). In the example previously provided (e.g., electronic mail), the requested resource is mail-related, so the micro-server 404 passes the user input to the mail module (which may comprise an e-mail or messaging application for example) at step 630.

At step 638, the mail module retrieves the data via the system APIs, such as e.g., a system messaging API 642 and/or system phonebook API 640.

At step 644, the mail module asynchronously receives data from the data store and at step 646, the mail module generates dynamic data for output. At step 648, the micro-server combines the data from the mail module with an XHTML template, and the MCD 100 returns to step 620 wherein the micro-server 404 prepares to send an HTTP response to the micro-browser 402. The MCD then transmits the response.

FIG. 6b illustrates the three primary (3) sub-processes used for various functions within the illustrated architecture. The first sub-process begins at step 650, wherein the micro-server 404 initiates an event connection. This may be followed by step 690 (denoted “E” on FIG. 6b, and discussed below), or the first sub-process can continue to step 660.

At step 660, it is determined whether the event is established or received on an asynchronous connection. If so, is it determined at step 664 whether the event requires loading a new URL. If so, the process proceeds to step 612 of FIG. 6a (“D”). If not, the process proceeds to step 662 (described below). Step 662 is also performed if it is determined at step 660 that the event was not established or received asynchronously.

At step 662, the scripting engine (part of the browser in the illustrated embodiment) updates the DOM as required (“C”). At step 652, the scripting engine runs the relevant scripts, accesses the DOM, registers events, etc. At step 654, it is determined whether any event connections are open and if so, step 660 (determination of asynchronous connections) is performed again. If not, the scripting engine opens an asynchronous event connection to the micro-server (step 656), and the micro-server initiates an event connection. Additionally, this may be initiated at step 658 when the micro-browser starts the scripting engine. After step 658, step 652 (running scripts, accessing DOM, etc.) is again performed.

The second sub-process of FIG. 6b starts at step 670, during which the micro-server 404 starts. At step 672, the micro-server starts the mail module, and the mail module accesses the network to check for new network data (step 674). At step 676, it is determined if any new network data is present and if not, step 674 (check for new data) is performed again. This check can be instigated at a prescribed periodicity, anecdotally, or otherwise.

If there is new network data present when the check is performed, the new data is stored in the data store 406 at step 678, and the second sub-process returns to step 644 of FIG. 6a (“A”). The data received from the second sub-process is subsequently retrieved per step 644, and the sub-process continues to step 674 to check for new network data.

The third sub-process of FIG. 6b begins at step 690, during which the micro-server 404 receives one or more event registrations. At step 686, the micro-server obtains any changes to the mail events from the mail module. At step 688, the micro-server then sends an events update message to the browser, over the established “remote event” channel. The process then returns to step 686; a new sub-process is triggered by each event registration. Step 692 can end the loop and sub-process in the event an event channel is closed (such as by the browser navigating away from the page or the channel being explicitly closed).

FIG. 7 is a flow chart illustrating the operation of a mobile communication device in accordance with another exemplary embodiment of the invention, wherein the micro-server process 404 acts as a proxy for one or more of the various entities (e.g., browser 402, remote server(s), etc.).

At step 700 (FIG. 7), the micro-browser receives user input of the type previously described. At step 702, it is determined whether the input requires loading a new uniform resource locator (URL) and if not, the micro-browser updates the document object model (DOM) at step 704. At step 708, the micro-browser 402 next renders the DOM, and at step 710, the micro-browser updates the MCD display. The process then returns to step 700.

If at step 702 it is determined that the input requires loading a new URL, the browser 402 prepares to send an HTTP request to the micro-server 404 at step 712. This request is transmitted to the micro-server at step 714, and at step 716 the micro-server 404 determines if the requested resource is in the (local MCD) cache. If so, the requested resource is retrieved from the cache at step 718. The micro-server 404 then prepares to send the HTTP response to the micro-browser at step 720. Then, at step 724 the HTTP response (including the requested cached resource) is transmitted to the micro-browser. At step 726, the micro-browser processes the response document into a DOM. The micro-browser 402 then renders the DOM, and updates the MCD display.

If at step 716 it is determined that the requested resource is not in the cache, the micro-server 404 determines which network connection(s) is/are needed to provide the requested resource (step 728). The micro-server then prepares to send an HTTP request to the relevant network agent(s) at step 730.

At step 738, the request is transmitted to the relevant agent(s) e.g., server(s), and at step 740 a response is received by the micro-server therefrom.

At step 742, the micro-server 404 processes the HTTP response from the network agent(s), and at step 744 determines whether the resource can be cached. If so, the resource is cached (step 746); if not, the micro-server prepares a response to the micro-browser 402, including the resource, or information relating to lack of access to the resource (step 720). The response is then transmitted to the micro-browser 402. The MCD then transmits the response to the browser 402, which then processes the response into a DOM.

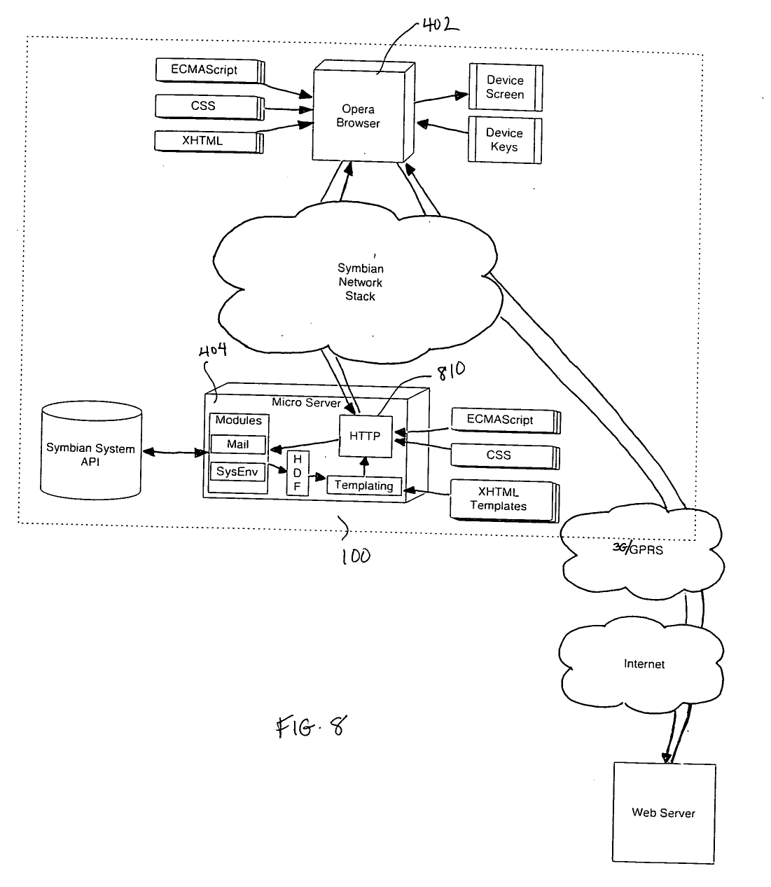

FIG. 8 illustrates one exemplary implementation of the MCD 100 using primarily commercially available components and software. In this configuration, the exemplary device comprises a Nokia Series 60 device with a variant of the well-known Opera Browser 402 running thereon. The micro-server 404 is implemented as a Symbian server (written in C++ and utilizing the Symbian software development kit (SDK). An HTTP server functionality is coded into a server application 810, built on a lightweight open-source template system. Dynamically loadable binary modules are used to implement applications such as mail. Static data files such as ECMAScript and CSS are disposed in the flash memory of the phone, and accessed using the server application 810. Data from the browser 402 is passed to the appropriate module, which processes it, gathers data from the (Symbian) API, and produces a hierarchical data format (HDF) file that can be processed along with appropriate XHTML template(s) present in the data store. The resulting complete XHTML file is then passed to the HTTP server and returned to the browser 402.

Business Methods and Products—

Great utility for the present invention can be found in the context of mobile devices such as PDAs, smart-phones, etc., since many users will want to utilize Internet or other network “browsing” functions, high-speed data access, etc. while operating in a mobile state. The installation of micro-server 404 and associated architecture elements by carriers or other service providers offers these providers an active point-of-presence on the subscriber's mobile device. This versatile and dynamic environment can be selectively controlled to varying degrees by the carrier, and can be used to improve the user's experience with the device (and the carrier's services).

For example, as previously noted, the micro-server 404 can be aware of other network technologies available to the MCD 100, and can make more efficient use of the network by acting as a gateway to alternate communications channels (e.g., asynchronous data channels), caching appropriate data locally, and receiving data asynchronously for later use. This functionality can provide the basis for a “premium” service or feature; e.g., as part of a variable subscription package. For example, in the context of the embodiment of FIG. 4c described above, the carrier or service provider could selectively enable or disable the user's MCD micro-server for certain types of functionality including, inter alia, the capability to asynchronously receive data via one or more alternate communication interfaces.

Similarly, such premium or selective functionality may be employed with respect to enabling the MCD 100 of a given subscriber to dynamically identify and add new interfaces to existing device functions. For example, as previously described, this can be accomplished by selective enabling of an “always-on” configuration which can receive updates to services on the mobile device automatically if the subscriber has been authorized for this function.

Furthermore, the aforementioned use of a “commodity” browser that can have its functionality extended via the server 404 allows for the extension of the MCD capabilities and functions by the MCD manufacturer and/service provider. This provides additional opportunities for commerce, including dynamic alteration or upgrade of the MCD configuration for a particular user (such as upon renewal of a subscription or payment of a fee, or as an incentive), such updates or alterations advantageously being conducted via the network interface (e.g., wireless link) to the MCD 100 in real-time.

The carrier or service provider can also even dynamically control the “look and feel” or presence on the MCD, such as where the browser display or user interface is modified anecdotally or from time-to-time, so as to accomplish certain goals (such as increased user satisfaction, highlight or altering the user to certain information or new functions, etc.).

Additionally, the micro-server of the present invention can add value to the browser interface (and hence provide the basis for another business model) by enabling connection cost and billing information to be presented and managed from the browser itself, thereby making the mobile device more user-friendly from, inter alia, a cost efficiency standpoint. It also optimizes the network usage for the service provider or carrier, thereby increasing the available bandwidth, reliability, etc. of the carrier's network.

The disclosed micro-server architecture can also be used to augment data presented to the user with context or other information (such as in the form of metadata) obtained from a third party, such as billing information from a network operator or service provider, advertisements (optionally based on or contextually related content of the other data presented), location data, etc.

Thus, a method and apparatus for providing a common interface for multiple entities (e.g., applications) in a mobile communication device has been described. Many other permutations of the foregoing system components and communication methods may also be used and are consistent with the present invention, as will be recognized by those of ordinary skill in the field.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A mobile communication device having at least one wireless interface, said device comprising:
a display unit configured to display information for a user;
an input unit configured to receive input from the user;
a microprocessor for executing software comprised of a plurality of modules;
a memory unit in data communication with said microprocessor, said memory unit being capable of storing said software, wherein said software modules are adapted to perform one or more functions of the mobile communication device, said modules comprising at least:
an application module;
a server module configured to generate first data in response to information provided by said application module; and
a browser module for displaying via said display unit at least said first data.

2. The mobile communication device as set forth in claim 1, wherein said application module comprises a module selected from the group consisting of: (i) a configuration module, and (ii) an electronic mail module.

3. The mobile communication device as set forth in claim 1, further comprising a data storage unit, wherein said server module generates said first data using data stored in said data storage unit.

4. The mobile communication device as set forth in claim 1, wherein said application module interfaces with said server module using an application programming interface (API).

5. The mobile communication device as set forth in claim 1, wherein said server module receives data from a data link established with an eternal server via a network, and said browser module displays second data received from said external server.

6. The mobile communication device as set forth in claim 2, further comprising a second application module, wherein said second application module is an electronic mail module, and wherein said application module and said second application module interface with said server module using an application programming interface (API).

7. A method of operating a mobile communication device having a display, browser and server, comprising:
controlling said display using at least said browser;
providing a first set of data to said browser using said sever; and
providing a second set of data to said browser from an external server in data communication with said mobile communication device.

8. The method a set forth in claim 7, wherein said mobile communications device further comprises a mail application and a data store, and said method further comprises:
requesting access to said mail application using at least a request from said browser;
forwarding said request to said mail application using said server;
generating a document using information stored in said date store, at least portions of said document being viewable using said browser;
transmitting said document to said browser using said server; and
displaying said at least portions of said document using said browser.

9. The method as set forth in claim 7, further comprising providing at least portions of said first set of data to said server using at least an application selected from the group consisting of: (i) an e-mail application, and (ii) a configuration application.

10. The method as set forth in claim 9, wherein said at least portions of said first set of data are provided to said server using an application programming interface (API).

11. The method as set forth in claim 7, further comprising receiving additional information at said server via a data link connection with an externally located server.

12. A device software architecture for use in a mobile communications device within a mobile communications network, the architecture comprising:
at least one first function operative to run on said device;
at least one second function external to said mobile communications device; and
at least one common interface for said plurality of functions, said at least one common interface comprising a server process running on said mobile communications device and adapted to at least receive and process information from both said at least first and second functions.

13. The device software architecture of claim 12, further comprising a browser process in data communication with said server process.

14. The device software architecture of claim 13, wherein said processing comprises formatting the information and delivering information to said browser process.

15. The device software architecture of claim 13, wherein said processing comprises:
receiving input from said browser process generated in response to user input thereto; and
forwarding at least a portion of said input to said at least one first application.

16. A mobile communications device, comprising:
a processor;
a storage device in data communication with said processor;
a wireless interface; and
a web server process running on said processor, said web server process also acting as an application server, said server process being adapted to dynamically generate data upon request from one or more entities associated with said mobile communications device.

17. The mobile communications device of claim 16, wherein said web server process further functions as a gateway to at least one asynchronous communication channel.

18. The mobile communications device of claim 16, wherein said web server process further functions as a proxy between a browser and a network entity.

19. A mobile communications device, comprising:
a processor;
a storage device in data communication with said processor;
a wireless interface; and
a server process running on said processor, said server process acting as an application server, said server process being capable of dynamically adding at least one new interfaces to a device functions using an “always-on” configuration capable of receiving updates to services on said mobile device substantially automatically.

20. A mobile communications device, comprising:
a microprocessor;
a storage device in data communication with said microprocessor;
a wireless interface configured to receive first information from a network server;
a display unit for displaying information to a user;
an configuration application running on said processor and adapted to configure at least one aspect of the mobile communication device, said configuration application providing configuration information using at least an application programming interface (API);
a micro-server for generating second information in response to said information from said configuration application; and
a micro-browser configured to display said first information and said second information on said display unit.

21. The mobile commutations device of claim 20, wherein said first and second information comprise data rendered in a hypertext transport protocol (HTTP) format.

22. The mobile commutations device of claim 20, wherein said micro-server receives said information from said configuration application via said mobile communication device application programming interface.

23. The mobile communication device of claim 20, further comprising:
an electronic communication application for receiving and sending electronic communications and for exchanging said communications with said micro-server using said application programming interface;
wherein said micro-server is further configured for generating third information in response to at least one of said communication from said e-mail application; and
wherein said micro-browser displays said third information on said display unit.

24. The mobile communication device as set forth in claim 23, wherein said micro-server generates fourth information in response to information received via an asynchronous data link, and said micro-browser displays said fourth information on said display unit.

25. The mobile communication device of claim 20, further comprising:
storing a static markup language page in said storage device, wherein:
said micro-server retrieves said static page from said storage device; and
said micro-browser displays said static page on said display unit.
